(19) United States
(12) Patent Application Publication
(10) Pub. No.: US 2023/0079971 A1
(43) Pub. Date: Mar. 16, 2023

(54) BIDIRECTIONAL COHERENT OPTICAL TRANSCEIVER WITH SELF-OPTIMIZATION AND COMMUNICATION METHOD THEREOF

(71) Applicant: NGUYEN TAN HUNG, Da Nang (VN)

(72) Inventor: NGUYEN TAN HUNG, Da Nang (VN)

(21) Appl. No.: 17/471,417

(22) Filed: Sep. 10, 2021

(51) Int. Cl. H04L 1/00; H04B 10/40; H04B 7/0413; H04B 10/079

(52) U.S. Cl. CPC H04L 1/0061; H04B 10/40; H04B 7/0413; H04B 10/07953

(57) ABSTRACT

In one embodiment, information passing mechanism between the two connected optical transceivers is provided. Within the first optical transceiver, Rx 1 calculates the current condition of the uplink channel and passes this information together with the condition of the downlink channel that it receives from Tx 2 to Tx 1. The Tx 1 uses the downlink channel condition that it receives from the Rx 1 to generate signal with appropriate modulation format, shaping factor, baudrate and coding scheme for maximizing the downlink's capacity. The Tx 1 then transmits this information together with the uplink channel condition received from Rx 1 to Rx 2. The Rx 2 uses the information about the modulation format, baudrate, shaping factor and coding scheme that it receives from Tx 1 for the reception of information-bearing signal. The Rx 2 then calculates the transmission channel condition of the downlink channel and passes this information together with the uplink channel condition that it receives from Tx 1 to Tx 2. The Tx 2 then uses the uplink channel condition that it receives from the Rx 2 to generate signal with optimized modulation format, shaping factor, baudrate and coding scheme for maximizing the uplink's capacity. The information exchange process between the two connected optical transceivers then repeats in an endless loop.

### TECHNICAL FIELD

The present disclosure relates to optical communication device and method, and more precisely but not exclusively, to a coherent optical transceiver which can self-optimize the baudrate, modulation format, error-forward correction scheme and shaping factor based on the transmission channel condition for maximizing the system performance and method thereof.

### BACKGROUND ART

This section introduces aspects that may help facilitate a better understanding of the disclosure. Accordingly, the statements of this section are to be read in this light and are not to be understood as admissions about what is in the prior art or what is not in the prior art.

Coherent optical communication is the main high-speed transport transmission technology for undersea, long-haul and metropolitan area networks. In practice, these optical networks contain a variety of optical fiber links which are constructed at different points in time. These optical fiber links have very different characteristics due to the different link lengths, different types of fiber and different amplification schemes. As a result, the capacities of different fiber links are also different. Due to the aging problem of fiber itself any many other network components, the capacities (or the maximum data rates) of all fiber links in the network slowly degrade over time. In addition, the capacities of many fiber links even vary quickly over a short period of time (e.g., over one day) due to their sensitivities with surrounding environment. For example, the fiber links installed along street with busy traffic in the metropolitan area networks are very sensitive to vibration caused by the traffic in rush hours. These links typically provide a much better signal-to-noise ratio (SNR) during the night than during the rush hours with busy traffic. Taking all these issues into account, optical fiber networks are usually designed with plenty of margin to provide a high reliability and prevent network failure. However, with a high network margin, the actual amount of data being transported over an optical fiber network is much smaller than the network capacity, which is very inefficient.

With the ever-increasing demand for connectivity, maximizing the capacity of fiber optical communication networks have become crucial in recent years. Laying out more fiber is extremely expensive and time-consuming, especially in big cities. Maximizing the capacity of fiber optical fiber networks require the development of a new class of flexible optical transceivers with flexible data rates adapted to the channel conditions. Due to the fast-varying nature of many optical fiber channels, the data rate adjustment of optical transceivers must be performed automatically. Providing effective mechanism and hardware designs for optical transceiver to achieve automatic and optimized data rate adjustment based on the optical channel condition is a big challenge that the fiber optical communication industry is facing.

For conventional coherent optical transceivers, the modulation format, symbol rate and coding schemes and thus the data rates can be adjusted based on the link length and optical channel conditions. For systems using probabilistic constellation shaping, the shaping factor (SF) can also be adjusted for maximizing the transmission performance. These tasks are usually done manually when initializing the link. This is due to the lack of effective mechanisms for providing essential feedback information to the transmitter during system's operation.

### SUMMARY OF INVENTION

In view of the foregoing problem, this invention disclosure provides methods for signal generating and processing in the transmitter (Tx) and the receiver (Rx) of a coherent optical transceiver to ensure an effective mechanism for seamless communication about the transmission channel condition between connected optical transceivers without interrupting the data transmission.

According to the first aspect of the invention, a communication method between connected bidirectional coherent optical transceivers for passing information on transmission channel condition is provided. The method comprises the steps of: generating signal with pre-set modulation format, baudrate, forward error correction (FEC) scheme and shaping factor, by transmitter (Tx) of the first optical transceiver, to transmit over a downlink, wherein the downlink is the transmission channel between the transmitter (Tx) of the first optical transceiver and receiver (Rx) of the second optical transceiver; receiving signal transmitted from Tx of the first optical transceiver and calculating the current downlink channel condition, by Rx of the second optical transceiver, by using the information about the modulation format, baudrate, FEC scheme and shaping factor received from Tx of the first optical transceiver; passing, by Rx of the second optical transceiver, the information on the calculated downlink channel condition to Tx within the second optical transceiver; generating signal with pre-set modulation format, baudrate and FEC scheme, shaping factor, by Tx of the second optical transceiver, to transmit this signal together with the information on the downlink channel condition received from Rx of the second optical transceiver to Rx of the first optical transceiver over an uplink, wherein the uplink is the transmission channel between the Tx of the second optical transceiver and Rx of the first optical transceiver; receiving signal transmitted from Tx of the second optical transceiver and calculating the current uplink channel condition, by Rx of the first optical transceiver, by using the information about the modulation format, baudrate, FEC scheme and shaping factor received from Tx of the second optical transceiver; passing, by Rx of the first optical transceiver, the information on the calculated uplink channel condition together with the information on the downlink channel condition received from Tx of the second optical transceiver to Tx within the first optical transceiver; using the information on the downlink channel condition received from the Rx within the first optical transceiver, by Tx of the first optical transceiver, to generate signal with optimized modulation format, baudrate, FEC scheme and shaping factor for maximizing the downlink's capacity; transmitting signal with the optimized modulation format, baudrate, FEC scheme and shaping factor together with the information on the uplink channel condition received from Rx within the first optical transceiver, by Tx of the first optical transceiver, to Rx of the second optical transceiver over the downlink; receiving the signal transmitted from Tx of the first optical transceiver and calculating the current downlink channel condition, by Rx of the second optical transceiver, by using the information about the optimized modulation format, baudrate, FEC scheme and shaping factor generated by Tx of the first optical transceiver; passing, by Rx of the second optical transceiver, the information on the calculated downlink channel condition together with the information on the uplink channel condition received from Tx of the first optical transceiver to Tx within the second optical transceiver; using the information on the uplink channel condition received from the Rx within the second optical transceiver, by Tx of the second optical transceiver, to generate signal with optimized modulation format, baudrate, FEC scheme and shaping factor for maximizing the uplink's capacity; transmitting signal with the optimized modulation format, baudrate, FEC scheme and shaping factor together with the information on the downlink channel condition received from Rx within the second optical transceiver, by Tx of the second optical transceiver, to Rx of the first optical transceiver over the uplink; and continuing the process of passing information on channel condition in an endless loop to update and monitor continuously and/or periodically the condition of downlink and uplink channel for optimizing the operating parameters of connected transceivers.

According to the second aspect of the invention, a processing method for a transmitter (Tx) in a bidirectional coherent optical transceiver to multiplex management message with transmitted data is provided. The method comprises the steps of: de-multiplexing data to be transmitted into data for transmission in x- and y-polarizations; receiving the management message sent by the Rx within the same optical transceiver and de-multiplexing the management message into control message and forwarding message, wherein the control message contains the information on direct transmission channel condition and the forwarding message contains the information on opposite transmission channel condition, wherein the direct transmission channel is the channel on which the Tx of this optical transceiver transmits data to the receiver end on the other side of the transmission channel, and the opposite transmission channel is an opposite one of the direct transmission channel; based on the information on direct transmission channel condition contained in the control message sent by the Rx within the same optical transceiver, choosing baudrate, modulation format, FEC scheme and shaping factor appropriately for maximizing the direct transmission channel's capacity by using a FEC and Modulation format pool; encoding and mapping data to be transmitted in x- and y-polarizations into Quadrature Amplitude Modulation (QAM) symbols by using the information on chosen baudrate, modulation format, FEC scheme and shaping factor; performing pulse-shaping for QAM symbols to generate the transmitted waveforms in x- and y-polarizations; multiplexing the information on chosen baudrate, modulation format, FEC scheme and shaping factor as a new control message with the forwarding message containing the information on the opposite transmission channel condition that the Tx received from the Rx within the same optical transceiver to form a new management message; encoding and mapping the new management message to simple BPSK format; performing pulse-shaping for resulted Binary Phase-Shift Keying (BPSK) symbols to generate a complex waveform, which is denoted as M(t), at baseband carrying the new management message; separating the generated waveform M(t) into two copies, and conjugating one copy of M(t) to obtain the conjugation of M(t) which is denoted as M*(t); multiplying exp(2πjf₀t) with M(t) and M*(t) by using a complex digital oscillator to shift these two signals to an intermediate frequency of f₀, wherein f₀ is the frequency separation between the QAM signal and M(t); splitting each of the received two signals, which are M(t) exp(2πjf₀t) and M*(t) exp(2πjf₀t), into two copies, one of which is conjugated to generate total four signals: M(t) exp(2πjf₀t), M*(t) exp(2πjf₀t), M(t) exp(−2πjf₀t), and M*(t) exp(−2πjf₀t); adding two resulted signals M(t) exp(2πjf₀t) and M*(t) exp(−2πjf₀t) to the QAM signal for transmission in x-polarization; and adding two remaining signals M(t) exp(−2πjf₀t) and M*(t) exp(2πjf₀t) to the QAM signal for transmission in y-polarization.

According to the third aspect of the invention, a processing method for a receiver (Rx) of a bidirectional coherent optical transceiver to demultiplex management message from received data is provided. The method comprises the steps of: receiving the incoming signal including information-bearing signal and monitoring signal sent by the Tx on the other side of the transmission channel, wherein information-bearing signal is QAM signal carrying transmitted data and monitoring signal is monitoring subcarriers carrying management message; generating Inphase and Quadrature signal components from the received incoming signal; combining the received Inphase and Quadrature signal components to form complex signals in x- and y-polarizations; performing chromatic dispersion (CD) compensation in x- and y-polarizations; at each polarization, splitting the resulted signal after CD compensation into two copies in which one copy is passed through an LPF (Low pass filter) for filtering out the QAM signal and the other one is passed through an HPF (High pass filter) for filtering out the monitoring subcarriers; feeding the filtered QAM signals in x- and y-polarizations into the first 2×2 MIMO (Multiple Input-Multiple Output) block for polarization de-rotation; feeding the information about the state of polarization obtained from the first 2×2 MIMO block into the second 2×2 MIMO block for performing polarization de-rotation and equalization for the filtered monitoring subcarriers in x- and y-polarizations; obtaining the management message carried in the filtered monitoring subcarriers after the second 2×2 MIMO block; detecting and decoding the received management message to obtain the information about control message and forwarding message included in this management message, wherein: the decoded control message comprises the information on baudrate, QAM format, shaping factor and FEC scheme which the transmitter (Tx) on the other side of the transmission channel chose for encoding data to be transmitted to this receiver over the direct transmission channel, the decoded forwarding message comprises the information on the opposite transmission channel condition which the Tx on the other side of the transmission channel received from Rx within its transceiver to forward to this receiver over the direct transmission channel, wherein the direct transmission channel is the channel on which the Tx on the other side of the transmission channel transmits data to this receiver, and the opposite transmission channel is an opposite one of the direct transmission channel; and using the information on baudrate, QAM format, shaping factor and FEC scheme obtained from the decoded control message to facilitate the carrier recovery, symbol detection, SNR (Signal-to-Noise Ratio) and OSNR (Optical Signal-to-Noise Ratio) estimation of the direct transmission channel and to decode the received data; forwarding the information on the opposite transmission channel condition as a new control message included in a new management message to the Tx within its transceiver; and forwarding the information on the direct transmission channel condition which being calculated after SNR and OSNR estimation as a new forwarding message included in a new management message to the Tx within its transceiver.

Preferably, after carrier recovery, sending the estimated frequency offset information between the local oscillator (LO) of the Rx and carrier frequency of the incoming signal back to the laser controller of the LO as a feedback signal through a low-speed digital-to-analog converter (DAC) to form a phase-locked loop (PLL).

### Advantageous Effects

Embodiments of the present invention provide a mechanism for passing information on transmission channel condition between connected coherent optical transceivers to create a flexible and smart optical transceiver which can self-optimize the baudrate, modulation format, error-forward correction scheme and shaping factor by using the feedback information on transmission channel condition for maximizing the transmission performance and system capacity. Further, thanks to appropriately adjusted data rate, the transmission channels are always ensured in operating state.

In addition, by encoding information on the transmission channel's condition on a pair of conjugated narrow-band subcarriers, multiplexing these subcarriers with information-bearing signal to be transmitted, detecting the conjugated pair of subcarriers at receiver end and processing signal appropriately for SNR enhancement, the present invention also provides an effective mechanism to enable the information passing mechanism between two connected optical transceivers without interrupting data transmission.

The effects of the present invention are not limited to the above-mentioned effects, and further effects not described above will be clearly understood by those skilled in the art from the appended claims.

### BRIEF DESCRIPTION OF THE DRAWINGS

The above and other aspects, features, and advantages of the disclosure will be more apparent from the following detailed description taken in conjunction with the accompanying drawings, in which:

FIG. 1 is a block diagram of a typical full-coherent optical transceiver;

FIG. 2 is a block diagram of a conventional DP-DSP (Dual-Polarization Digital Signal Processor) for data reception and equalization in a conventional coherent optical receiver;

FIG. 3 is a schematic diagram of the concept of optical transceiver operating in a bidirectional transmission mode according to an embodiment of the present invention;

FIG. 4 is a flowchart of information passing mechanism between the two connected optical transceivers according to an embodiment of the present invention;

FIG. 5 illustrates overall architecture of an optical transceiver with information passing mechanism between the transmitter (Tx) and receiver (Rx) within the same transceiver about the transmission channel condition;

FIG. 6 is a schematic diagram of structure and contained information for management messages of Tx and Rx in uplink and downlink direction according to an embodiment of present invention;

FIG. 7 is a schematic structural diagram of the DSP block of the Tx according to an embodiment of the present invention;

FIG. 8 is a schematic diagram of multiplexing QAM (Quadrature Amplitude Modulation) signal with two pairs of subcarriers for channel monitoring in x- and y-polarizations in the frequency domain according to an embodiment of the present invention;

FIG. 9 is a schematic structural diagram of the DSP block of the Rx according to an embodiment of the present invention;

FIG. 10 is a schematic diagram of electrical spectra of signals after LPF 1 and LPF 2 according to an embodiment of the present invention;

FIG. 11 is a schematic diagram of electrical spectra of signals after HPF 1 and HPF 2 according to an embodiment of the present invention;

FIG. 12 is a schematic structural diagram of the DSP block for the detection and decoding of the management message at the Rx according to an embodiment of the present invention; and

FIG. 13 is a schematic diagram of outputs of 4 LPFs according to an embodiment of the present invention.

### DETAILED DESCRIPTION OF EMBODIMENTS OF THE INVENTION

Technical solutions in embodiments of the present disclosure are described below in connection with the accompanying drawings in the embodiments of the present disclosure. Obviously, the described embodiments are part of the embodiments of the present disclosure, but not all the embodiments. Based on the embodiments in the present disclosure, all other embodiments obtained by a person of ordinary skill in the art without creative work fall within the protection scope of the present disclosure.

It should be understood that in the following description, well known elements, functions, operations, techniques, etc. may not be described or illustrated in detail to avoid obscuring the subject matter of the disclosure.

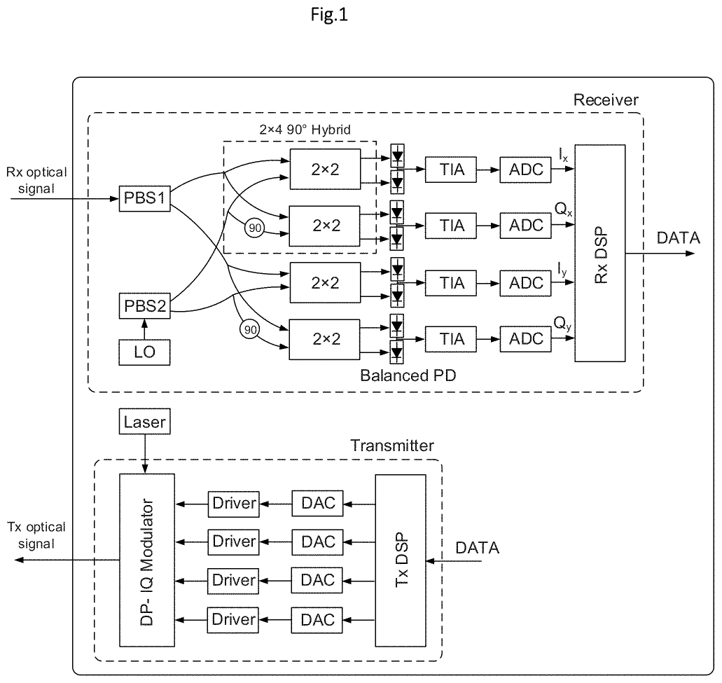

With reference to FIG. 1, the following describes a typical full-coherent optical transceiver.

The transmitter of a typical full-coherent optical transceiver may include a Tx DSP (Digital Signal Processor); 4 DACs (Digital to Analog Converter); 4 RF (Radio Frequency) drivers; and a DP-IQ (Dual-Polarization Inphase and Quadrature) modulator with a laser. At the transmitter, the Tx DSP accepts incoming data and generates 4 digital signals for modulating the Inphase and Quadrature components of x- and y-polarizations of an optical carrier. Then, the 4 digital signals are converted into 4 analog waveforms using 4 DACs. These 4 analog signals are then amplified using 4 RF drivers (electrical amplifier). An DP IQ modulator is used then to modulate these 4 signals into the amplitude and phase of the x- and y-polarizations of an optical carrier.

At the receiver side, a conventional coherent receiver is used to convert the optically modulated signal into the electrical domain. The conventional coherent receiver includes a local oscillator (LO); two polarization beam splitters (PBS), two 2×4 90-degree hybrids, 4 balanced photodetectors (PD), 4 transimpedance amplifiers (TIA); 4 analog-to-digital converters (ADC) and a dual-polarization DSP (DP-DSP), which performs channel equalization (polarization demultiplexing, polarization mode dispersion compensation, chromatic dispersion compensation), timing and carrier recovery, detection and decoding. Specifically, incoming optical signal is fed into the first PBS to split into TE (Transverse Electric) and TM (Transverse Magnetic) mode, and the local oscillator (LO) is also split into TE and TM mode using the second PBS. The signals output from the PBSs are then mixed using 2×4 90-degree hybrids. The outputs of these optical hybrids are fed into 4 pairs of balanced PD. The outputs of these balanced PDs are fed into 4 TIAs and then digitized by 4 ADCs. The outputs of 4 ADCs, namely Iₓ, Qₓ, I_{y}, Q_{y} are fed into a Rx DSP. Then, the Rx DSP may perform chromatic dispersion (CD) compensation, polarization de-rotation and polarization mode dispersion (PMD) compensation, timing recovery, carrier recovery, symbol detection and decoding at each polarization to receive the transmitted data.

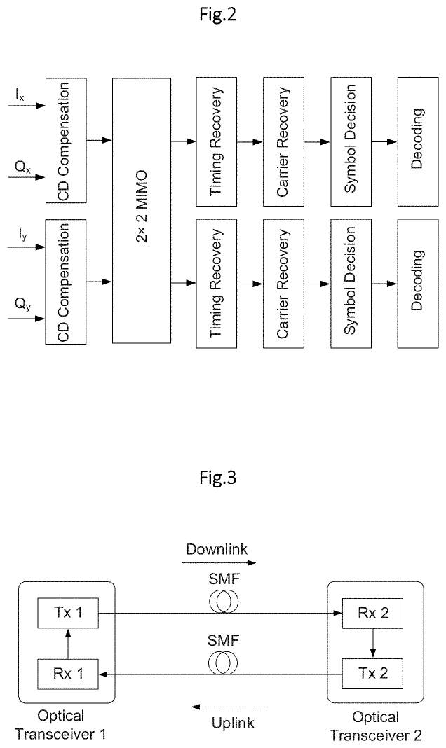

FIG. 2 is a block diagram of a conventional DP-DSP for data reception and equalization in a conventional coherent optical receiver.

As shown in FIG. 2, the DP-DSP includes chromatic dispersion (CD) compensation blocks for the received signals in x- and y-polarizations, a 2×2 MIMO (Multiple Input Multiple Output) block for polarization de-rotation and polarization mode dispersion (PMD) compensation. Then, for each polarization, timing recovery, carrier recovery, symbol detection and decoding are performed.

For conventional coherent optical transceivers, the modulation format, symbol rate and coding schemes and thus the data rates can be adjusted based on the link length and optical channel conditions. For systems using probabilistic constellation shaping, the shaping factor (SF) can also be adjusted for maximizing the transmission performance. These tasks are usually done manually when initializing the link. This is due to the lack of effective mechanisms for providing essential feedback information to the transmitter during system's operation. Solving this problem requires novel transceiver design and effective mechanisms for seamless communication between the transmitter end and the receiver end about the link condition without interrupting the data transmission.

The present invention provides methods for signal generation and signal processing, and especially provides an effective mechanism for communication between the Tx and Rx within a coherent optical transceiver and between connected coherent optical transceivers to exchange essential information about the transmission channel that the Tx can use to adaptively choose modulation formats, baudrate, shaping factor and coding scheme for maximizing the transmission performance and system capacity. The general concept of such optical transceiver operating in a bidirectional transmission mode, where the transmitter (Tx) and the receiver (Rx) can pass feedback information about the transmission channel, is illustrated in FIG. 3.

FIG. 3 is a schematic diagram of the concept of optical transceiver operating in a bidirectional transmission mode according to an embodiment of the present invention.

Referring to FIG. 3, the transmitter of the first optical transceiver (Tx 1) is connected to the receiver of the second optical transceiver (Rx 2). This transmission link may be referred to the “downlink”. The transmitter of the second optical transceiver (Tx 2) is connected to the receiver of the first optical transceiver (Rx 1) through the “uplink”. A person of ordinary skill in the art will understand that the concepts of “uplink” and “downlink” here are interchangeable and are used here for illustration purpose only. The “downlink” and “uplink” can be realized using different fibers or a single full-duplex fiber.

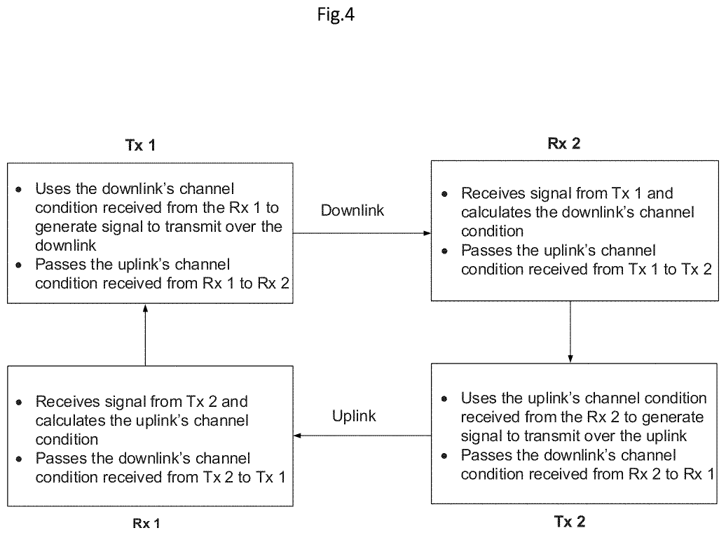

FIG. 4 is a flowchart of information passing mechanism between the two connected optical transceivers according to an embodiment of the present invention.

As shown in FIG. 4, within the first optical transceiver, Rx 1 calculates the current condition of the uplink channel and passes this information together with the condition of the downlink channel that it receives from Tx 2 to Tx 1. The Tx 1 uses the downlink channel condition that it receives from the Rx 1 to generate signal with appropriate modulation format, shaping factor, baudrate and coding scheme for maximizing the downlink's capacity. The Tx 1 then transmits this information together with the uplink channel condition received from Rx 1 to Rx 2. The Rx 2 uses the information about the modulation format, baudrate, shaping factor and coding scheme that it receives from Tx 1 for the reception of information-bearing signal. Then the Rx 2 calculates the transmission channel condition of the downlink channel and passes this information together with the uplink channel condition that it receives from Tx 1 to Tx 2. The Tx 2 then uses the uplink channel condition that it receives from the Rx 2 to generate signal with appropriate modulation format, shaping factor, baudrate and coding scheme for maximizing the uplink's capacity. The information exchange process between the two connected optical transceivers then repeats in an endless loop.

To effectively enable the information passing mechanism between two connected optical transceivers without interrupting data transmission, the invention provides method for encoding information on the transmission channel's condition on a pair of conjugated narrow-band subcarriers, which are called monitoring subcarriers; method for multiplexing these monitoring subcarriers with information-bearing signal to be transmitted; and method for detecting the conjugated pair of subcarriers at receiver end and processing signal appropriately for SNR enhancement.

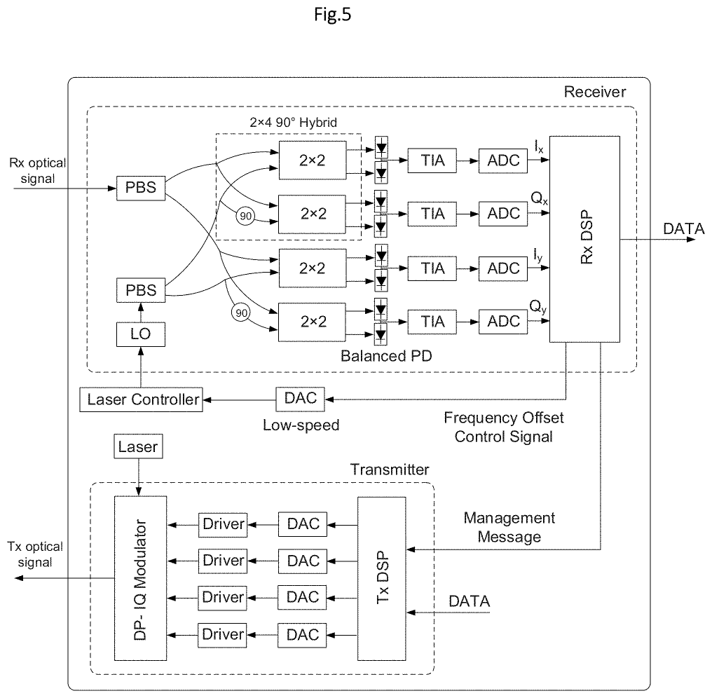

FIG. 5 illustrates overall architecture of an optical transceiver with information passing mechanism between the transmitter (Tx) and receiver (Rx) within the same transceiver about the transmission channel condition.

As shown in FIG. 5, at the receiver, incoming optical signal is split into TE and TM mode using a polarization beam splitter (PBS). The local oscillator (LO) is also split into TE and TM mode using yet another PBS. The TE modes from incoming optical signal and LO are then mixed using a 2×4 optical hybrid. The 4 outputs of this optical hybrid are fed into two pairs of balanced PD. The outputs of these two balanced PDs are fed to two TIA and then digitized by two ADCs. Similar procedure is applied for the TM modes of the incoming signal and LO. The outputs of 4 ADCs, namely Iₓ, Qₓ, I_{y}, Q_{y} are fed into a DSP. The Rx DSP first separates the information bearing signal from the monitoring signal transmitted on two pairs of subcarriers carrying channel state information sent by the Tx on the other side of the transmission channel. The Rx DSP then decodes the information in these monitoring subcarriers for obtaining information about the baudrate, modulation format, coding schemes which are needed for the reception and detection of the transmitted data. The monitoring subcarriers also contain information about the state of the transmission channel in the opposite direction. After the reception of the main transmitted data, the Rx DSP can calculate the SNR and OSNR of the direct transmission channel. It then passes this information together with the information about the opposite channel received from the Tx on the other side of the transmission channel to the Tx within the same optical transceiver. To facilitate the reception of the monitoring subcarriers, the information about the frequency offset between the LO and carrier frequency of the incoming optical signal, which is obtained after DSP, is fed back to the laser controller of the LO through a low-speed DAC. This feedback signal is used to minimize the frequency offset between the LO and carrier frequency of the incoming optical signal and effectively acting as a phase-locked loop (PLL).

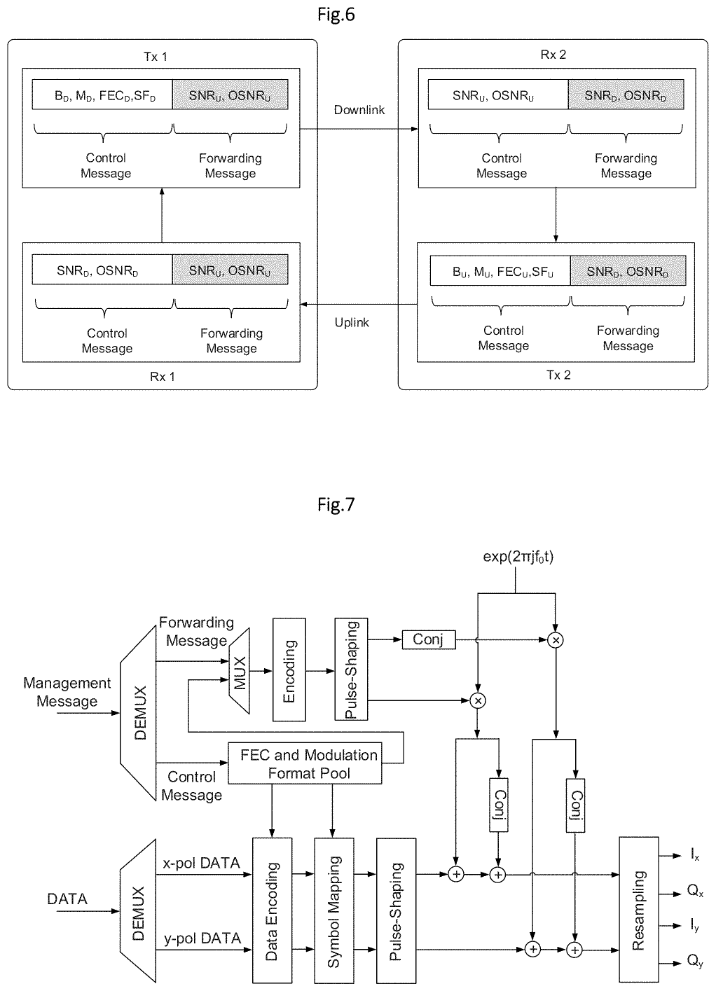

FIG. 6 is a schematic diagram of structure and contained information for management messages of Tx and Rx in uplink and downlink directions according to an embodiment of the present invention.

Tx and Rx pass to each other a management message, which contains two parts, namely the control message and the forwarding message. The control message is used to facilitate the data reception at the designated Rx or encoding at Tx end. The forwarding message is the part to be forwarded to the next Tx and Rx in the chain (as shown in FIG. 3). For the Tx, the control message includes information about the baudrate (B_{U} and B_{D} for uplink and downlink cases), quadrature-amplitude-modulation (QAM) format order (M_{U} and M_{D} for uplink and downlink cases), the FEC scheme (FEC_{U} and FEC_{D} for uplink and downlink cases) and the shaping factor in the case of probabilistic shaping is used (SF_{U} and SF_{D} for uplink and downlink cases). For the Rx, the control message includes information about the SNR and OSNR of the direct and opposite links (SNR_{U}, OSNR_{U} and SNR_{D}, OSNR_{D} for uplink and downlink cases).

Referring to FIG. 6, at the time of initializing the downlink, the Tx 1 generates signal with pre-set parameters of B_{D}, M_{D}, FEC_{D}, SF_{D}. The Tx 1 transmits these pre-set B_{D}, M_{D}, FEC_{D}, SF_{D} parameters under the form of a management message to the Rx 2 over the downlink. After receiving the management message from Tx 1, the Rx 2 uses the information on B_{D}, M_{D}, FEC_{D}, SF_{D} included in the management message to decode transmitted data and calculate SNR_{D} and OSRN_{D} of the downlink. Then, the calculated SNR_{D} and OSRN_{D} parameters are forwarded to the Tx 2 within the same transceiver. Likewise, the Tx 2 generates signal with pre-set parameters B_{U}, M_{U}, FEC_{U}, SF_{U} and transmits these B_{U}, M_{U}, FEC_{U}, SF_{U} parameters together with the SNR_{D} and OSRN_{D} received from Rx 2 under the form of control message and forwarding message of a management message to Rx 1 over the uplink. After receiving the management message from Tx 2, the Rx 1 uses the received information on B_{U}, M_{U}, FEC_{U}, SF_{U} to encode data transmitted by Tx 2 and calculate SNR_{U} and OSRN_{U} of the uplink. Then, the Rx 1 forwards the calculated SNR_{U} and OSRN_{U}, and the SNR_{D} and OSRN_{D} received from Tx 2 to the Tx 1 within the same transceiver. At this time, the Tx 1 uses the information on SNR_{D} and OSRN_{D} forwarded from Rx 1 to optimize B_{D}, M_{D}, FEC_{D}, SF_{D} parameters, and then the Tx 1 transmits signal with the optimized B_{D}, M_{D}, FEC_{D}, SF_{D} under the form of a control message and forwards the SNR_{U} and OSRN_{U} received from Rx 1 under the form of a forwarding message to the Rx 2 over the downlink. After receipt of the management message including control message and forwarding message from Tx 1, the Rx 2 then calculates the current downlink condition, i.e. SNR_{D} and OSRN_{D} based on the optimized B_{D}, M_{D}, FEC_{D}, SF_{D} received from Tx 1. Next, the Rx 2 forwards the calculated SNR_{D} and OSRN_{D}, and the SNR_{U} and OSRN_{U} received from Tx 1 to the Tx 2. At this time, the Tx 2 uses the information on SNR_{U} and OSRN_{U} forwarded from Rx 2 to optimize B_{U}, M_{U}, FEC_{U}, SF_{U} parameters, and then the Tx 2 transmits signal with the optimized B_{U}, M_{U}, FEC_{U}, SF_{U} under the form of a control message and forwards the SNR_{D} and OSRN_{D} received from Rx 2 under the form of a forwarding message to the Rx 1 over the uplink. The exchange information process between the two connected optical transceivers then repeats in an endless loop. With the described information passing mechanism, it can be achieved smart optical transceivers which can self-adjust automatically and continuously their operating parameters, i.e. modulation format, baudrate, SF and coding scheme, to adapt transmission channel's current condition. This can help maximizing the transmission capacity and ensuring that transmission channels are always in operation.

FIG. 7 is a schematic structural diagram of the DSP block of the Tx according to an embodiment of the present invention.

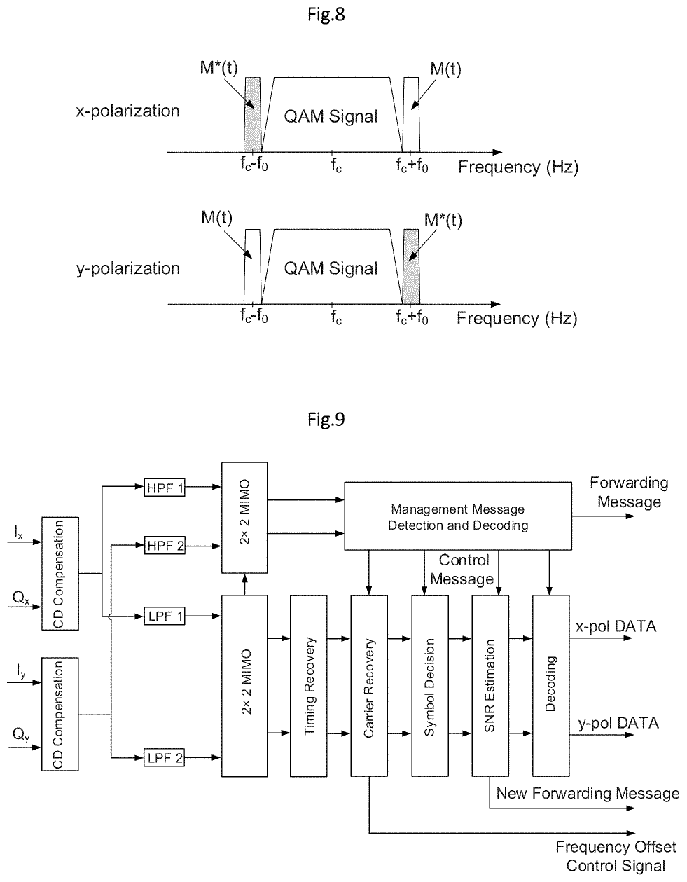

As shown in FIG. 7, the inputs of the Tx are the data to be transmitted and the management message that is sent by the Rx within the same transceiver. For the transmitted data, it is separated into data for transmission in x- and y-polarizations. The management message received from Rx within the same transceiver is separated into control message and forwarding message, in which the control message contains the information about the direct link condition. Using the information on the direct link condition, appropriate modulation formats, coding scheme, baudrate and shaping factor are chosen using a FEC and Modulation format pool. Then using the information on chosen modulation format, coding scheme, baudrate and shaping factor, the transmitted data in x- and y-polarizations are encoded and mapped into QAM symbols. Then transmitted waveforms for QAM signals in each polarization are generated through pulse-shaping. The selected baudrate, modulation format, FEC scheme and shaping factor are multiplexed with the forwarding message that the Tx received from the Rx within the same optical transceiver to form a new management message. This new management message is then encoded and mapped to a simple BPSK format. Then using pulse-shaping, a complex waveform at baseband carrying management message, herein referred to as waveform M(t), is generated. This waveform then will be transmitted in the edge of the QAM signal spectrum in both x and y-polarizations as shown in FIG. 8.

FIG. 8 is a schematic diagram of multiplexing QAM (Quadrature Amplitude Modulation) signal with two pairs of subcarriers for channel monitoring in x- and y-polarizations in the frequency domain according to an embodiment of the present invention.

As shown in FIG. 8, for the x-polarization, the conjugation of M(t), which is denoted as M*(t), is transmitted at the left-hand side and M(t) is transmitted in the right-hand side of the QAM signal spectrum. For the y-polarization, opposite arrangement is made. The frequency separation between the QAM signal and monitoring subcarrier M(t) is f₀. In general, the baudrate of M(t) is much smaller than those of the QAM signal:

B_{M}<<B_{U} and B_{M}<<B_{D}

The multiplexing scheme of the QAM signal with the channel monitoring subcarriers carrying management message is shown in FIG. 7. The generated signal M(t) is separated into 2 copies, one copy of M(t) is conjugated to obtain the conjugation of M(t) which is denoted as M*(t). One complex digital oscillator is used to generate exp(2πjf₀t). This is then used to multiply with M(t) and M*(t) to shift these two signals to an intermediate frequency of f₀. The outputs of these operations are M(t) exp(2πjf₀t) and M*(t) exp(2πjf₀t).

Next, each of these two signals is then split into two copies, one of which is conjugated to generate 4 following signals:

M(t) exp(2πjf₀t), M*(t) exp(2πjf₀t), M(t) exp(−2πjf₀t), and M*(t) exp(−2πjf₀t)

Then two following signals are added to the QAM signal in x-polarization:

M(t) exp(2πjf₀t) and M*(t) exp(−2πjf₀t),

Then two following signals are added to the QAM signal in y-polarization:

M(t) exp(−2πjf₀t) and M*(t) exp(2πjf₀t).

FIG. 9 is a schematic structural diagram of the DSP block of the Rx according to an embodiment of the present invention.

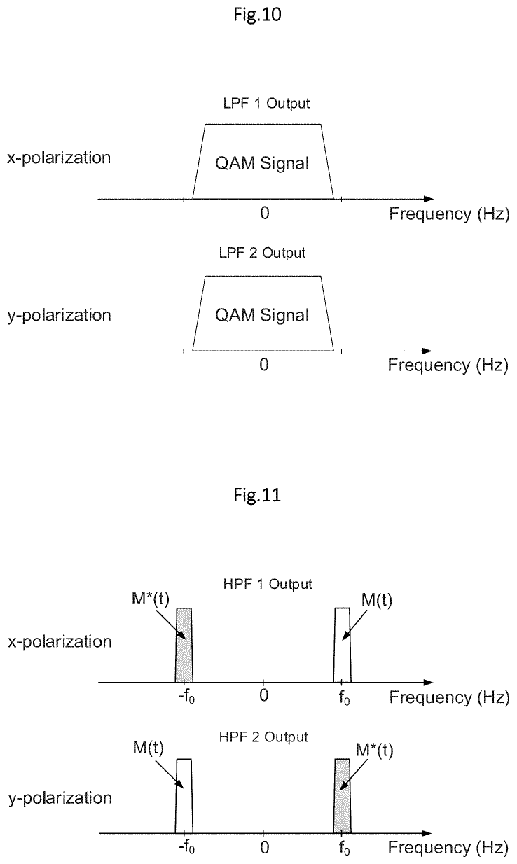

As shown in FIG. 9, for each polarization, firstly the received Inphase and quadrature components (Iₓ, Qₓ, I_{y}, Q_{y}) are combined to form complex signals in x- and y-polarizations. Then CD compensation is performed. For each polarization, the resulted signal is split into two copies, one of this is passed through an LPF for filtering out the QAM signal and the other one is passed through an HPF for filtering out the monitoring subcarriers carrying management message sent by transmitter end on the other side of the transmission channel. The electrical spectra of signals after the LPFs and HPFs are shown in FIG. 10 and FIG. 11.

FIG. 10 is a schematic diagram of electrical spectra of signals after LPF 1 and LPF 2 according to an embodiment of the present invention.

FIG. 11 is a schematic diagram of electrical spectra of signals after HPF 1 and HPF 2 according to an embodiment of the present invention.

Referring to FIG. 9, the filtered QAM signals in x- and y-polarizations are fed into the first 2×2 MIMO block for polarization de-rotation. The obtained information about the state of polarization is fed into the second 2×2 MIMO block for performing the same (i.e. polarization de-rotation and equalization) for the detected monitoring subcarriers in x- and y-polarizations. After that, the management message including control message and forwarding message sent by the Tx on the other side of the transmission channel, which carried in the filtered monitoring subcarriers, is detected and decoded. The obtained information from the detected control message, which comprises baudrate, QAM format, shaping factor and FEC scheme that the Tx chose for encoding transmitted data, is used to facilitate the carrier recovery, symbol detection, SNR estimation and decoding of the transmitted data. The decoded forwarding message, which comprises the information on the transmission channel condition in the opposite direction, is forwarded as a new control message included in a new management message to the Tx within its transceiver. After carrier recovery, the estimated frequency offset is sent back to the LO laser controller as a feedback signal through a low-speed DAC to form an PLL. The information on the direct transmission channel condition which being calculated after SNR and OSNR estimation is sent as a new forwarding message included in a new management message to the Tx within its transceiver.

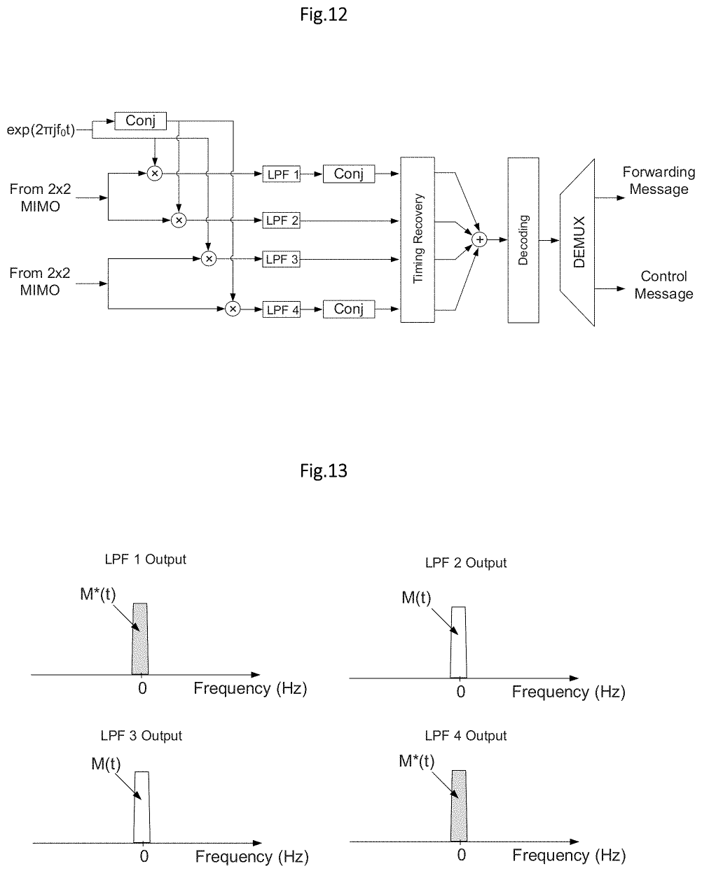

FIG. 12 is a schematic structural diagram of the DSP block for the detection and decoding of the management message at the Rx according to an embodiment of the present invention.

FIG. 13 is a schematic diagram of outputs of 4 LPFs according to an embodiment of the present invention.

As shown in FIG. 12, at first, all the 4 monitoring subcarriers are converted to baseband using a digital oscillator exp(2πjf₀t) and 4 LPFs. The outputs of these 4 LPFs are illustrated in FIG. 13. Two of 4 output signals are conjugated, then the 4 resulted signals are corrected for timing and coherently combined to enhance the SNR by up to 6 dB. This is a major advantage scheme as it guarantees the reliability in the transmission quality of the monitoring subcarriers. These subcarriers should be transmitted error free in all link conditions. As the SNR is high enough, no FEC scheme can be used for the monitoring channels. After decoding, the management message is separated into forwarding message to be passed further and control message to be used for the reception and detection of the user data.

Although the present disclosure has been described with various embodiments, various changes and modifications may be suggested to one skilled in the art. It is intended that the present disclosure encompass such changes and modifications as fall within the scope of the appended claims.

1. A communication method between connected bidirectional coherent optical transceivers for passing information on transmission channel condition, the method comprising:
generating signal with pre-set modulation format, baudrate, forward error correction (FEC) scheme and shaping factor (SF), by transmitter (Tx) of the first optical transceiver, to transmit over a downlink, wherein the downlink is the transmission channel between the transmitter (Tx) of the first optical transceiver and receiver (Rx) of the second optical transceiver;
receiving signal transmitted from Tx of the first optical transceiver and calculating the current downlink channel condition, by Rx of the second optical transceiver, by using the information about the modulation format, baudrate, FEC scheme and shaping factor received from Tx of the first optical transceiver;
passing, by Rx of the second optical transceiver, the information on the calculated downlink channel condition to Tx within the second optical transceiver;
generating signal with pre-set modulation format, baudrate and FEC scheme, shaping factor, by Tx of the second optical transceiver, to transmit this signal together with the information on the downlink channel condition received from Rx of the second optical transceiver to Rx of the first optical transceiver over an uplink, wherein the uplink is the transmission channel between the Tx of the second optical transceiver and Rx of the first optical transceiver;
receiving signal transmitted from Tx of the second optical transceiver and calculating the current uplink channel condition, by Rx of the first optical transceiver, by using the information about the modulation format, baudrate, FEC scheme and shaping factor received from Tx of the second optical transceiver;
passing, by Rx of the first optical transceiver, the information on the calculated uplink channel condition together with the information on the downlink channel condition received from Tx of the second optical transceiver to Tx within the first optical transceiver;
using the information on the downlink channel condition received from the Rx within the first optical transceiver, by Tx of the first optical transceiver, to generate signal with optimized modulation format, baudrate, FEC scheme and shaping factor for maximizing the downlink's capacity;
transmitting signal with the optimized modulation format, baudrate, FEC scheme and shaping factor together with the information on the uplink channel condition received from Rx within the first optical transceiver, by Tx of the first optical transceiver, to Rx of the second optical transceiver over the downlink;
receiving the signal transmitted from Tx of the first optical transceiver and calculating the current downlink channel condition, by Rx of the second optical transceiver, by using the information about the optimized modulation format, baudrate, FEC scheme and shaping factor generated by Tx of the first optical transceiver;
passing, by Rx of the second optical transceiver, the information on the calculated downlink channel condition together with the information on the uplink channel condition received from Tx of the first optical transceiver to Tx within the second optical transceiver;
using the information on the uplink channel condition received from the Rx within the second optical transceiver, by Tx of the second optical transceiver, to generate signal with optimized modulation format, baudrate, FEC scheme and shaping factor for maximizing the uplink's capacity; and
transmitting signal with the optimized modulation format, baudrate, FEC scheme and shaping factor together with the information on the downlink channel condition received from Rx within the second optical transceiver, by Tx of the second optical transceiver, to Rx of the first optical transceiver over the uplink;
continuing the process of passing information on channel condition in an endless loop to update and monitor continuously and/or periodically the condition of downlink and uplink channel for optimizing the operating parameters of connected transceivers.

2. The method according to claim 1, wherein the information on optimized modulation format, baudrate, FEC scheme and shaping factor together with the information on the uplink channel condition are encoded on two pairs of narrow-band subcarriers and multiplexed with information-bearing signal to be transmitted by Tx of the first optical transceiver over the downlink.

3. The method according to claim 2, wherein information-bearing signal is encoded and mapped into QAM (Quadrature Amplitude Modulation) symbols to be transmitted by Tx of the first optical transceiver over the downlink.

4. The method according to claim 1, wherein the information on downlink channel condition calculated by Rx of the second optical transceiver comprises the SNR (Signal-to-Noise Ratio) and OSNR (Optical Signal-to-Noise Ratio) of the downlink.

5. The method according to claim 1, wherein the information on optimized modulation format, baudrate, FEC scheme and shaping factor together with the information on the downlink channel condition are encoded on two pairs of narrow-band subcarriers and multiplexed with information-bearing signal to be transmitted by Tx of the second optical transceiver over the uplink.

6. The method according to claim 5, wherein information-bearing signal are encoded and mapped into QAM symbols to be transmitted by Tx of the second optical transceiver over the uplink.

7. The method according to claim 1, wherein the information on uplink channel condition calculated by Rx of the first optical transceiver comprises SNR and OSNR of the uplink.

8. A processing method for a transmitter (Tx) in a bidirectional coherent optical transceiver to multiplex management message with transmitted data, the method comprising:
de-multiplexing data to be transmitted into data for transmission in x- and y-polarizations;
receiving the management message sent by the Rx within the same optical transceiver and de-multiplexing the management message into control message and forwarding message, wherein the control message contains the information on direct transmission channel condition and the forwarding message contains the information on opposite transmission channel condition, wherein the direct transmission channel is the channel on which the Tx of this optical transceiver transmits data to receiver end on the other side of the transmission channel, and the opposite transmission channel is an opposite one of the direct transmission channel;
based on the information on direct transmission channel condition contained in the control message sent by the Rx within the same optical transceiver, choosing baudrate, modulation format, FEC scheme and shaping factor appropriately for maximizing the direct transmission channel's capacity by using a FEC and Modulation format pool;
encoding and mapping data to be transmitted in x- and y-polarizations into QAM symbols by using the information on chosen baudrate, modulation format, FEC scheme and shaping factor;
performing pulse-shaping for QAM symbols to generate the transmitted waveforms in x- and y-polarizations;
multiplexing the information on chosen baudrate, modulation format, FEC scheme and shaping factor as a new control message with the forwarding message containing the information on opposite the transmission channel condition that the Tx received from the Rx within the same optical transceiver to form a new management message;
encoding and mapping the new management message to simple BPSK (Binary Phase-Shift Keying) format;
performing pulse-shaping for resulted BPSK symbols to generate a complex waveform, which is denoted as M(t), at baseband carrying the new management message;
separating the generated waveform M(t) into two copies, and conjugating one copy of M(t) to obtain the conjugation of M(t) which is denoted as M*(t);
multiplying exp(2πjf₀t) with M(t) and M*(t) by using a complex digital oscillator to shift these two signals to an intermediate frequency of f₀, wherein f₀ is the frequency separation between the QAM signal and M(t);
splitting each of the received two signals, which are M(t) exp(2πjf₀t) and M*(t) exp(2πjf₀t), into two copies, one of which is conjugated to generate total four signals: M(t) exp(2πjf₀t), M*(t) exp(2πjf₀t), M(t) exp(−2πjf₀t), and M*(t) exp(−2πjf₀t);
adding two resulted signals M(t) exp(2πjf₀t) and M*(t) exp(−2πjf₀t) to the QAM signal for transmission in x-polarization; and
adding two remaining signals M(t) exp(−2πjf₀t) and M*(t) exp(2πjf₀t) to the QAM signal for transmission in y-polarization.

9. The method of claim 8, wherein the information on transmission channel condition comprises the SNR and OSNR of the transmission channel.

10. A processing method for a receiver (Rx) of a bidirectional coherent optical transceiver to demultiplex management message from received data, the method comprising:
receiving the incoming signal including information-bearing signal and monitoring signal sent by the Tx on the other side of the transmission channel, wherein information-bearing signal is QAM signal carrying transmitted data and monitoring signal is monitoring subcarriers carrying management message;
generating Inphase and Quadrature signal components from the received incoming signal;
combining the received Inphase and Quadrature signal components to form complex signals in x- and y-polarizations;
performing chromatic dispersion (CD) compensation in x- and y-polarizations;
at each polarization, splitting the resulted signal after CD compensation into two copies in which one copy is passed through an LPF (Low pass filter) for filtering out the QAM signal and the other one is passed through an HPF (High pass filter) for filtering out the monitoring subcarriers;
feeding the filtered QAM signals in x- and y-polarizations into the first 2×2 MIMO block for polarization de-rotation;
feeding the information about the state of polarization obtained from the first 2×2 MIMO (Multiple Input-Multiple Output) block into the second 2×2 MIMO block for performing polarization de-rotation and equalization for the filtered monitoring subcarriers in x- and y-polarizations;
obtaining the management message carried in the filtered monitoring subcarriers after the second 2×2 MIMO block;
detecting and decoding the received management message to obtain the information about control message and forwarding message included in this management message, wherein:
the decoded control message comprises the information on baudrate, QAM format, shaping factor and FEC scheme which the transmitter (Tx) on the other side of the transmission channel chose for encoding data to be transmitted to this receiver over the direct transmission channel,
the decoded forwarding message comprises the information on the opposite transmission channel condition which the Tx on the other side of the transmission channel received from Rx within its transceiver to forward to this receiver over the direct transmission channel,
wherein the direct transmission channel is the channel on which the Tx on the other side of the transmission channel transmits data to this receiver, and the opposite transmission channel is an opposite one of the direct transmission channel; and
using the information on baudrate, QAM format, shaping factor and FEC scheme obtained from the decoded control message to facilitate the carrier recovery, symbol detection, SNR and OSNR estimation of the direct transmission channel and to decode the received data;
forwarding the information on the opposite transmission channel condition as a new control message included in a new management message to the Tx within its transceiver; and
forwarding the information on the direct transmission channel condition which being calculated after SNR and OSNR estimation as a new forwarding message included in a new management message to the Tx within its transceiver.

11. The method according to claim 10, wherein detecting and decoding the received management message to obtain the information about control message and forwarding message of the transmitter end comprises:
converting the monitoring subcarriers to baseband using a digital oscillator exp(2πjf₀t) and LPFs;
correcting for timing and coherently combining the resulted monitoring subcarriers to receive the management message; and
decoding and demultiplexing the received management message into control message and forwarding message.

12. The method according to claim 10, wherein the information on the transmission channel condition comprises the SNR and OSNR of the transmission channel.

13. The method according to claim 10, further comprising:
after carrier recovery, sending the estimated frequency offset information between the local oscillator (LO) of the Rx and carrier frequency of the incoming signal back to the laser controller of the LO as a feedback signal through a low-speed digital-to-analog converter (DAC) to form a phase-locked loop (PLL).
